(19) United States
(12) Patent Application Publication
(10) Pub. No.: US 2017/0258095 A1
(43) Pub. Date: Sep. 14, 2017

(54) PESTICIDE COMPOSITION

(71) Applicant: Luis Augusto Mazariegos Hurtado, Cali (CO)

(72) Inventor: Luis Augusto Mazariegos Hurtado, Cali (CO)

(21) Appl. No.: 15/512,067

(22) PCT Filed: Sep. 17, 2015
(86) PCT No.: PCT/IB2015/057179

§ 371 Date: Mar. 17, 2017

(30) Foreign Application Priority Data
Sep. 17, 2014 (CO) 14-206728

(51) Int. Cl. A01N 65/12; A01N 63/04

(52) U.S. Cl. CPC A01N 65/12; A01N 63/04

(57) ABSTRACT

The invention relates to pesticide compositions for the biological control of mites and insects, comprising at least one entomopathogenic microorganism, botanical pyrethrum extract and adjuvants, incorporated in a suitable vehicle. The invention also relates to the use of said compositions for the control of pest insects and mites and disease vectors in conventional and non-conventional agricultural crops.

### TECHNICAL FIELD

The present invention relates to compositions for the biological control of pests and vectors comprising an entomopathogenic microorganism, pyrethrum botanical extract and adjuvants in an acceptable carrier. The pesticidal compositions of the invention show a synergistic effect and proven efficiency against mites and sucking insects and foliage eaters in all kinds of plants.

### DESCRIPTION OF THE STATE OF THE ART

The intensive use of chemical pesticides in recent years, has led to a significant deterioration of the environment, creating potential risks to consumer health and harmful effects on non-targeted species, such as the occurrence of secondary pests, the phytotoxic reaction in treated plants and the resistance development of populations of mites and insect pests. Examples of chemical pesticides resistance can be found in most mites and insects pests.

The two spots mite (Tetranychus urticae), the best known member of the Tetranychidae or spider mites family, is a species of extremely polyphagous mite that feeds on plants and has a high potential for resistance development due to its short life cycle and their high reproductive potential.

The western flower thrips (Frankliniella occidentalis) is a species native from the United States southwestern that feeds on more than 500 different species of host plants, including a large number of fruits, vegetables and ornamental crops. F. occidentalis has great potential to develop resistance due to the short generation time, high fertility and parthenogenetic reproduction.

Whitefly, Bemisia tabaci or Trialeurodes vaporariorum, is an insect pest belonging to the Homoptera order. The crops that are the most affected by this insect are tomato, pepper, cucumber, beans and snuff. Generated damages start at the time when the fly is installed on the underside of the host leaf and both adult and nymphal state, begin to feed on it, thus impairing the growth of it.

The Myzus persicae, known as the green peach aphid, is the most significant aphid infestation of these trees because it causes a growth reduction and foliage wilting. M. persicae has a remarkable ability to generate mechanisms that prevent or exceed the toxic effects of insecticides with at least seven independent resistance mechanisms and also acts as a vector for transporting plant viruses.

In the case of pests that affect humans, the emergence of insecticide resistance in Anopheles species vectors has been an inevitable consequence of malaria control. Resistance to pyrethroids in the last 10 years in the major malaria vectors in Africa has increased significantly. The populations of bedbugs have also become highly resistant to pyrethroids, so that efforts to control them very rarely work.

Therefore, biological control has become an important alternative because it is more selective and less environmentally destructive way to control various pests. The use of microorganisms such as bacteria, viruses, fungi, protozoa and nematodes to reduce and stabilize the populations of mites and insects and insect pests is increasingly studied. Among the various approaches to use natural enemies of insects as biological control agents, one of the most common is the mass multiplication of pathogens such as bacteria or fungi and its application to an affected area as biopesticide.

Today bacteria and fungi are the most commonly used microorganisms as biopesticidal agents. For example, strains of the bacterium Bacillus thuringiensis have been used against susceptible species of Lepidoptera, Diptera and Coleoptera. Similarly, there are entomopathogenic microorganisms, which are able to infect and cause death to various insects, becoming to an alternative to be formulated, either alone or in combination with other biocidal compounds to reduce the risk of resistance development. More than 100 genera and 700 species of entomopathogenic fungi are known.

Entomopathogenic fungi have very special features that allow them to survive in the form parasitic on insects and saprofita form of decaying plant material. The saprophytic growth can result in the production of conidiophores and conidia mycelial development, allowing the fungus to be produced in the laboratory using appropriate techniques. Among the wide variety of known entomopathogenic fungi, Beauveria spp, Nomuraea spp, Paecelomyces spp and Metarhizium spp genres stand out.

Some plant substances are also very useful for pest control. Neem oil is a naturally occurring pesticide found in the seeds of the Azadirachta indica tree. Among the active ingredients that make up Neem oil, azadirachtin is the most outstanding, but also other terpenoids like Nimbin were found.

The pyrethrum botanical extract is a biological insecticide derived from dried flowers of Chrysanthemum (Chrysanthemum cinerariaefolium and Chrysanthemum cineum), is composed of six individual pyrethrins: pyrethrin I, pyrethrin II, cinerine I, cinerine II, jasmolin I and jasmolin II, each one of those exhibits a particular insecticidal effect. This insecticide is biodegradable and degrades with exposure to light or oxygen.

Bu its effectiveness in controlling pests and vectors, bio-insecticides can be produced from different genera and species of entomopathogenic fungi whose active ingredient is the mushroom itself. Examples of these proven effective bioinsecticides products are Green Guard® made from Metarhizium anisopliae Acridum var. for locust control, NoFly@ made from Paecilomyces fumosoroseus to control whitefly and thrips, Mycotal® made from Lecanicillium lecanii to control whitefly. Other commercial products as Mycotrol ES®, Naturalis L® BotaniGard®, Tracer® Conidia® and are also widely known.

Document CN103461387, which comprises Beauveria bassiana and chlorpyrifos. U.S. Pat. No. 5,888,989 discloses the insecticidal compositions comprising silafluofen and/or etofenprox with entomopathogenic fungi selected from the group consisting of Hirsutella, Verticillium, Metarhizium, Beauveria, Paecilomyces and Nomuraea.

Likewise they have been reported several insecticidal compositions comprising pyrethrum botanical extract. EP 0713647 discloses compositions comprising pyrethrum extract with UV protecting agents, whereas U.S. Pat. No. 8,658,223 and WO2013087709 documents disclose insecticidal compositions comprising pyrethrum botanical extract in combination with one or more biocides.

Although biological control agents are being actively developed, currently very few broad spectrum biopesticides are able to control effectively a wide range of insects that attack crops. By combining entomopathogenic microorganisms and natural botanical extracts in pesticidal compositions, the potential resistance development can be reduced, and many pest control programs would be stabilized, reducing the amount of active ingredient needed and minimizing the waste amounts.

### BRIEF DESCRIPTION OF THE INVENTION

The present invention relates to pesticidal compositions comprising at least one entomopathogenic microorganism with pyrethrum botanical extract and adjuvants, demonstrating a proven effectiveness against mites, thrips, aphids, mealybugs, psyllids, soft scales, whiteflies, mealybugs, leafhoppers, weevils, bugs, borers, beetles, mites and insects in all kinds of plants.

The invention also contemplates the use of such compositions for phytosanitary control of pests and disease vectors. Surprisingly, the combination of an entomopathogenic microorganism with pyrethrum botanical extract in the compositions of the invention, introduced a synergistic effect and a broad insecticide and acaricide spectrum.

### BRIEF DESCRIPTION OF THE DRAWINGS

FIG. 1. Treatment efficacy on nymphs of T. urticae.

FIG. 2. Effectiveness of treatments on adult T. urticae.

FIG. 3. Effectiveness of treatments on adult Epitrix sp.

FIG. 4. Efficacy of treatments on adult Macrosiphum sp.

FIG. 5. Survival values (%) of T. vaporariorum nymphs, 10 days after applying the evaluated treatments.

FIG. 6. Hatching values (%) of T. vaporariorum eggs, 10 days after applying the evaluated treatments.

### DETAILED DESCRIPTION OF THE INVENTION

The invention relates to a composition for controlling pest mites and insects comprising at least one entomopathogenic microorganism, a natural extract which is obtained from the Chrysanthemum cinerariaefolium and Chrysanthemum cineum flowers (pyrethrum botanical extract) and adjuvants, formulated in an acceptable carrier, allowing it to be applied in all kinds of crops, both conventional and unconventional.

For purposes of the present invention, the term “pest mites and insects” includes insects recognized by those skilled in the art as whiteflies, aphids, thrips, mites, mealybugs, psyllids, soft scales, jump foliage and leafhoppers, weevils, bugs plants, drillers, foliage-eating insects, scarab beetles and foliage eaters in all kinds of plants, ticks and mosquitoes and/or diseases transmitters.

Entomopathogenic microorganisms of the compositions of the present invention include, but are not limited to Beauveria spp, Metarhizium spp, Paecilomyces spp, Lecanicillium spp, Nomuraea spp and Entomophthora spp. In a preferred embodiment of the invention, the entomopathogenic microorganism or microorganisms is in the form of conidia. Conidia are asexual spores proper of many fungi that are tolerant to high temperatures, relatively stable under different environmental conditions and that can be quantified and used as units of measurement to evaluate parameters such fungi viability and lethal dose (LD₅₀).

The term “LD₅₀” means the median lethal dose of entomopathogenic fungus that kills 50% of the insects receiving that dose and is measured in number of conidia. The DL so can be determined with respect to a group of insects in a laboratory bioassay. The bioassay was performed by making serial dilutions of the fungus and applying several times an individually known amount in to a group of insects monitoring the daily mortality and the acquired data are analyzed by known methods to determine the LD₅₀.

In a preferred embodiment of the invention, the entomopathogenic microorganism is a fungus of the Beauveria spp genus, more preferably a strain of Beauveria bassiana either alone or in combination with other entomopathogenic microorganism. The term “a strain of Beauveria bassiana” includes strains or isolates of Beauveria bassiana which have characteristics allowing them to be pathogenic for pest mites and insects. These strains typically produce high concentrations of stable conidia that are infective for the penetration of the insect cuticle, causing infection with morbidity by two or four days and death of the insect in a period ranging from 3 to 10 days.

Like most entomogenous fungi, Beauveria bassiana initiates infection by germinating the spores (conidia) that adheres and penetrates the cuticle of the host insect, which may explain the high virulence of the fungus. As the fungus penetrates the insect pest cuticle, the invasive hyphae penetrate host tissues and ramify through the haemocoele. The bodies or segments of the hyphae are distributed throughout the haemocoele filling the dying insect with mycelia. Hyphae appear through the insect's integument and produce spores on the external surface of the host.

After infection and penetration of the host insect cuticle by Beauvena bassiana, fungus releases various metabolites (mycotoxins) mainly beauvericin and beauveriolide (cyclodepsipeptides comprising a 3-hydroxy-4-methyl fatty acid, two L-amino acids and a D-amino acid) that induce movement the of extracellular Ca²⁺ in the cytosol increasing Ca²⁺ intracellularly, which results in the release of Cyt-C from mitochondria. Finally, the Cyt-C activated caspase triggers apoptosis and subsequent cell death.

In a further preferred embodiment of the invention, the entomopathogenic microorganism of the pesticidal compositions is the Beauveria bassiana BbGHA1991 strain, which is a highly pathogenic strain which has high production efficiency and increased stability at different temperature from other strains of Beauveria comparable virulence.

The term “pyrethrum botanical extract” means a natural insecticide found in Chrysanthemum cineranaefolium and Chrysanthemum cineum plants. To obtain it, plant flowers are harvested shortly after flowering and then dried or powdered and/or extracted with solvent oils. The pyrethrum botanical extract comprises six compounds from 2 ester groups: esters of chrysanthemic acid (pyrethrin I, cinerin I, jasmolin I) and pyrethric acid esters (pyrethrin II, cinerin II, jasmolin and jasmolin II) whose formulas are following:
pyrethrin I: (Z)—(S)-2-methyl-4-oxo-3-(penta-2,4dienyl-)cyclopent-2-enyl(1R,3R)-2,2-dimethyl-3-(2-methyl-prop-1-enyl)cyclopropane carboxylate;
pyrethrin II: (Z)—(S)-2-oxo Methil-3-4-(penta-2,4-dienyl)cyclopent-2-enyl (E)-(1R,3R)-3-(2-methoxycarbonyl-prop-1-enyl)-2,2-dimethyl-cyclopropane carboxylate;
Cinerin I: (Z)—(S)-3-(but-2-enyl)-2-methyl-4-oxocyclopent-2-enyl (1R,3R)-2,2-dimethyl-3-(2-methylprop-1-enyl) cyclopropane carboxylate:
Cinerin II: (Z)—(S)-3-(but-2-enyl)-2-methyl-4-oxocyclopent-2-enyl (E)-(1R,3R)-3-(2-methoxy-1-carbonylpropenyl)-2,2-dimethyl-cyclopropane carboxylate;
jasmolin I: (Z)—(S)-2-methyl-4-oxo-3-(pent-2-enyl)cyclopent-2-enyl (1R,3R)-2,2-dimethyl-3(2-1-metilprop-enyl) cyclopropane carboxylate;
jasmolin II: (Z)—(S)-2-methyl-4-oxo3-(pent-2-enyl)cyclopent-2-enyl(E)-(1R) trans-3-(1-enyl-2metoxicarbonilprop)-2,2-dimethyl-cyclopropane carboxylate.

Pyrethrum botanical extract has a very low mammalian toxicity and are rapidly degraded in the environment by photolysis, hydrolysis and biodegradation. The pyrethrins of pyrethrum extract induce a toxic effect when they penetrate the cuticle and reaching the nervous system of insects, where the sodium channels (responsible for the transmission of nerve signals) are joined along nerve cells, obstructing and generating hyperarousal and loss of nerve cell function and subsequent insect death.

The pesticidal compositions of the invention comprise at least one entomopathogenic microorganism in combination with pyrethrum botanical extract, at least one adjuvant and an acceptable carrier. As co-adjuvants may be mentioned, for example, water, organic solvents harmless, vegetable oils (eg sesame oil), alcohols, polyols (eg glycerol), excipients (eg kaolins, clays, talc), emulsifying agents, surfactants and stabilizers.

The acceptable carrier for purposes of the present invention can be defined as a substance or mixture of substances (eg oils, emulsions and suspensions) capable of dispersing the active components without affecting its ability to perform its intended function. The compositions may be in the form of oil, emulsion or suspension type. The term “oil” is intended to include substances that are viscous, oily liquid at ordinary temperatures. The oils may be petroleum or vegetable. Light oils include paraffinic oils, and other petroleum-based oils and vegetable oils, such as those derived from corn, coconut oil, cottonseed, soybeans, sunflower seeds and palm kernel.

For purposes of this invention, the term “emulsion or suspension type” it is intended to include mixtures of two not mutually soluble liquids capable of suspending the microorganism conidia and pyrethrum extract botanical. The emulsions include oil and water mixtures which seek to promote suspension and/or allow a high dispersion of the microorganism.

For the preparation of the compositions of the invention can be mixed in a suitable container under sterile conditions, the vehicle and coadjuvants maintaining constant agitation. Pyrethrum botanical extract is added and the mixture is stirred until a homogeneous suspension. Finally preserving the sterile conditions and agitation, microorganisms (conidia) suspended until a homogeneous mixture is added to this preparation.

The pesticidal compositions of the present invention have a synergistic action, are effective against pests and mites and insects can be stored and transported through commercial distribution channels without special handling. Additionally, the compositions of the invention have minimal adverse effects on the environment on non-target species, including humans. In a preferred embodiment, the compositions of the invention preferably comprise from 1×10⁶ and 1×10¹² conidia/mL of entomopathogenic microorganism and between 0.001% and 5.0% w/v botanical pyrethrum extract, along with an acceptable carrier and coadjuvants.

In a preferred embodiment, the pesticidal compositions of the invention comprise from 1×10⁷ and 1×10¹⁰ conidia/mL of Beauveria bassiana, from 0.3% to 0.9% w/v botanical extract pyrethrum, a glycol and oil. Beauveria bassiana conidia are suspended in the oil containing the extract and glycol and incorporated in a vehicle type emulsion. The resulting composition is stable (more stable than if the conidia are suspended in water) and can be stored at temperatures up to 30° C.

A further embodiment of the present invention relates to the use of the compositions of the invention for pest control of mites and insects. The compositions may be applied to the target areas by land or air, for example, using a spray device.

The present invention will be presented in detail through the following examples, which are provided for illustrative purposes only and not with the aim of limiting the scope of the present invention.

### Examples

### Example 1: Preparation of the Strain and Conidia of Beauveria bassiana (BbGHAI 991)

The strain of Beauveria bassiana BbGHAI 991 was obtained from the collection of entomopathogenic fungi from the United States Department of Agriculture (USDA), Ithaca, N.Y. and designated the ARSEF 201 deposit, which was originally isolated from a corn rootworm (Diabrótica undecimpunctata).

The conidia of Beauveria bassiana BbGHA1 991 are produced by solid state fermentation and after separation by sieving to obtain an approximate concentration of 1×10¹¹ conidia/g.

### Example 2: Obtaining the Pyrethrum Botanical Extract

From Chrysanthemum cinerariaefolium and Chrysanthemum cineum flowers the pyrethrum extract was obtained by the following process: the dried flowers were milled and a first percolation solution was extracted with hexane. This solution was filtered and evaporated to a viscous brown dark greenish liquid called “brut” or “oleoresin”, which contains about 30% of pyrethrins and 67% of other plant substances.

The crude extract was divided in a solvent and then ogánico decolorized. The solvent was distilled off and the residue was dissolved in the final diluent with higher boiling point. Pyrethrins concentration was adjusted to a standard level by adding an isoparaffinic diluent.

As a final result refined pyrethrum extract 50% v/v, containing about 50% of pyrethrins and 37% of other plant substances and their characterization is obtained as follows:
Conversion factor (20° C. 101 kPa): 1 mg/m3=0.074 ppm (for pyrethrin I)
Molecular formula: C₂H₂₈O₃ (MW 328.4 g/mol for pyrethrin I)
Solubility: insoluble in water; soluble in organic solvents.
Boiling point: 146-150° C. (for pyrethrin I); 192-193° C. (for pyrethrin II)
Vapor pressure: 0-20° C. torr.

### Example 3: Preparation of Pesticidal Compositions

Pesticidal compositions of Beauveria bassiana BbGHA1991 and pyrethrum botanical extract were prepared. Initially, it is added botanical pyrethrum extract an oily vehicle containing a surfactant or surfactant to a final concentration of extract 1, 0%. In the suspension containing pyrethrum extract, Beauveria bassiana BbGHA1991 were conidia suspended to a concentration between 1×10⁹ and 1×10¹² conidia/L. Other components of the composition are shown in Table 1.

TABLE 1

| COMPONENT | CONCENTRATION |
|---|---|
| Beauveria bassiana BbGHA1991 strain | 1 × 10⁹-1 × 10¹² conidia/L |
| pyrethrum botanical extract | 5-20 g/L |
| Polyethylene Glycol trimethyl nonyl ether | 80-120 g/L |
| Paraffinic hydrotreated mineral oil | c.s.p. 1.0 L |

The final concentration of conidia was determined by hemacytometer counting and viability by a germination test. The viability of the conidia in preparations evaluated in all bioassays was above 85%.

### Example 4. Efficacy Trials

The purpose of evaluating the effectiveness in the laboratory is to estimate the effects arising from the use of the compositions at different doses to determine the lowest effective dose. The test laboratory under controlled environments eliminates other biotic factors that can affect the test.

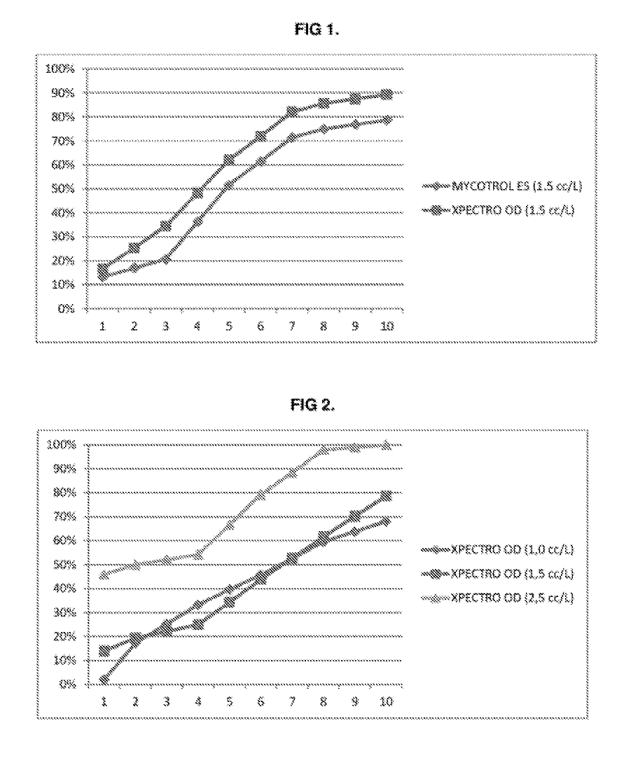

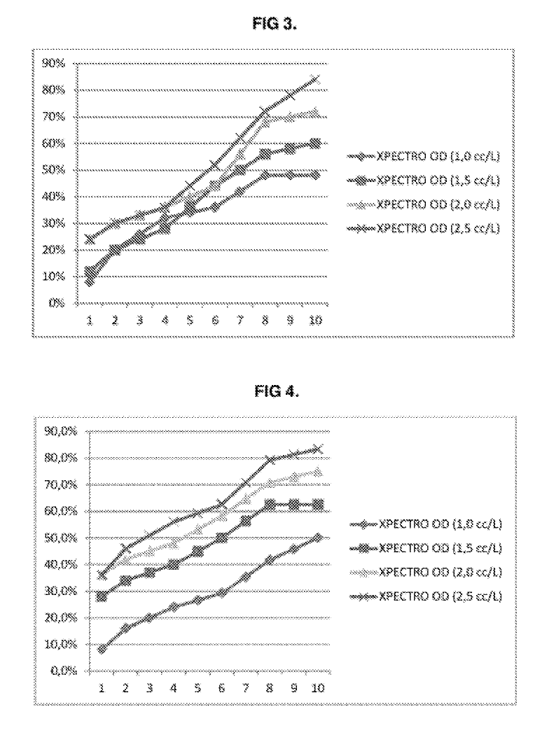

A pesticidal composition obtained according to Example 3 (XPECTRO OD) was determined at different doses effectiveness by applying direct and indirect contact about nymphs and adults, Trialeurodes vaporariorum, Tetranychus urticae, Epitrix sp, Macrosiphum sp. The percentages of T. vaporariorum effectiveness are shown in Table 2 and behavior of the effectiveness of treatments for T urticae, Epitrix sp and Macrosiphum sp are illustrated in FIGS. 1 to 4.

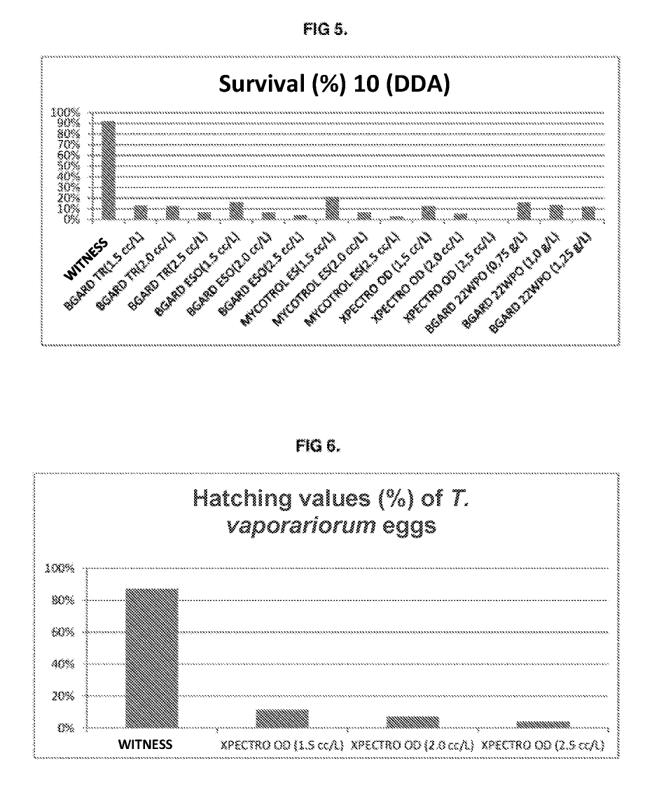

The survival values (%) of T. vaporariorum nymphs 10 days after (10 DAA) application illustrated in FIG. 5, while the Hatching values (%) of T. vaporariorum eggs (10 DAA) are illustrated in FIG. 6.

Product application was performed using a microapplicator (airbrush) at a distance of 15 cm and an angle of 45 and on the application unit, achieving a uniform coverage with fine droplets. The application was carried out directly on adults collected from breeding, which were placed in a box with a mesh that allows passage of the droplets in the spray. The application quality was verified through a water sensitive paper strip.

Then were let to dry at room and five individuals to be deposited into a ring of acrylic on the underside of a leaflet rose who was also previously applied were taken. For treatment 5 experimental units were placed on trays for easy transfer mounted. Evaluation units remained within a closed system with controlled temperature (20±1© C.), relative humidity (70±10%) and photoperiod of 12 h light/dark room.

The implemented experimental design was completely at random (DCA) with varying survival by counting the number of live and dead adults daily for 10 days after application. Quantification of the efficacy percentage was made by the Henderson and Tilton formula as set out below:

% Efficacy=100*(1−ta′TD/TA′td))

### Where:

TA: Treatment prior to application,
ta: Witness before application,
TD: Treatment after application.
td: Witness after application.

For the statistical analysis used statistical program R (The R Foundation for Statistical Computing, Version 2.9.0 (2009)), in which an analysis of variance (ANOVA) was developed to establish significant differences in the bioassay and then a Tukey test to determine between which of the evaluated treatments such differences are expressed using an alpha or significance level of 0.05.

TABLE 2
Values of treatment efficacy on T. vaporariorum. Nymphs

| | EFFICACY (%) |
|---|---|
| TREATMENT | 10 days after application |
| BGARD TR (1.5 cc/L) | 87.0 |
| BGARD TR (2.0 cc/L) | 87.4 |
| BGARD TR (2.5 cc/L) | 93.5 |
| BGARD ESO (1.5 cc/L) | 83.5 |
| BGARD ESO (2.0 cc/L) | 93.5 |
| BGARD ESO (2.5 cc/L) | 96.1 |
| MYCOTROL ES (1.5 cc/L) | 79.1 |
| MYCOTROL ES (2.0 cc/L) | 93.5 |
| MYCOTROL ES (2.5 cc/L) | 97.0 |
| BGARD 22WPO (0.75 g/L) | 83.9 |
| BGARD 22WPO (1.0 g/L) | 86.5 |
| BGARD 22WPO (1.25 g/L) | 88.3 |
| XPECTRO OD (1.5 cc/L) | 87.4 |
| XPECTRO OD (2.0 cc/L) | 94.8 |
| XPECTRO OD (2.5 cc/L) | 100.0 |

### Example 5. Efficacy Testing by Direct Contact on Eggs, Nymphs and Whitefly Adults in Cotton Crops (Bemisia tabaci)

The main objective of the assessment is to evaluate the efficacy benefits derived from the use of the compositions in its recommended minimum effective dose and to define the conditions of use of the product. The effectiveness can be defined as the net result of an equation that balances the positive effects of treatment on crop protection preventing any negative effect on the crop or production system in a broader sense.

The positive effects of plant protection products can be expressed in terms of a reduction of an insect pest that occurs in a crop of damage to crops, increasing crop yields, protection and improvement of crop quality, etc, while the negative effects include phytotoxicity to adjacent crops, reduced yields of subsequent crops, adverse effects on pollinators, increased risk of development of resistance and effects that reduce the sustainability of the production system.

For the test in the cultivation of cotton, spraying compositions obtained according to Example 3 were directed to foliage application equipment that generate turbulence, such as motors, so that the product covered sites (eg undersides of leaves) where conventional applications not arrive. The applied dose was 250 ml per 100 liters of water (2.5 ml per liter) and the objective was to control the eggs, nymphs and adults of Bemisia tabaci.

15 plants at random per lot, one leaf per plant (5 or 6) for a total of 15 samples were taken. They were marked with a circle whitefly nymphs present on the underside of the sheet indicating their nymphal stage (N1, N2, N3, N4 or pupa) to conduct assessments of control. Monitoring readings whitefly populations were made before each application 4 and 8 days after each application.

It should be understood that the present invention is not limited to the embodiments described and illustrated, since, as will be apparent to one skilled in the art, variations and possible modifications that do not depart from the spirit of the invention, which is only found defined by the claims.

### REFERENCES

1. Casida, J.; Quistad, G. Pyrethrum Flowers: Production, Chemistry, Toxicology; Oxford University Press, New York, 1995.
2. Environmental Protection Agency. Beauveria bassiana Strain GHA (128924) Technical Document. Biopesticides and Pollution Prevention Division (751 1 P); Office of Pesticide Programs, Washington, D.C. 2000.
3. Kubicek, C; Druzhinina, I. Entomopathogenic Fungi and Their Role in Pest Control, In: Environmental and Microbial Relationships. The Mycota. Springer-Verlag Berlin Heidelberg, 2007; pp 159-187.
4. Torsten Hothorn, Brian S. Everitt. A Handbook of Statistical Analyses Using R, 2nd ed.; Chapman and Hall/CRC, 2009.
5. Sjut, V.; Butters, J. Molecular Mechanisms of Resistance to Agrochemicals; Springer-Verlag Berlin Heidelberg, 1997.

1. A pesticidal composition comprising an effective amount of:
a) an entomopathogenic microorganism; and
b) pyrethrum botanical extract; together with an adjuvant and an acceptable carrier.

2. A pesticidal composition according to claim 1 wherein the effective amount of the entomopathogenic microorganism is between 1×10⁷ and 1×10¹¹ conidia/mL.

3. A pesticidal composition according to claim 1 wherein the effective amount of pyrethrum botanical extract is between 0.001% and 1.5% w/v.

4. A pesticidal composition according to claim 1 wherein the entomopathogenic microorganism is selected from the group consisting of Beauveria spp, Metarhizium spp, Paecilomyces spp, Lecanicillium spp, Nomuraea spp and Entomophthora spp and combinations thereof.

5. A pesticidal composition according to claim 1 wherein the entomopathogenic microorganism is of the Beauveria spp genus.

6. A pesticidal composition according to claim 5 wherein the entomopathogenic microorganism is Beauveria bassiana BbGHA1991.

7. A pesticidal composition according to claim 1 comprising the following components:

| COMPONENT | CONCENTRATION |
|---|---|
| Beauveria bassiana BbGHA1991 strain | 1 × 10⁹ conidia/L |
| pyrethrum botanical extract | 5-20 g/L |
| Polyethylene Glycol trimethyl nonyl ether | 80-120 g/L |
| Paraffinic hydrotreated mineral oil | c.s.p. 1.0 L |

8. A pesticidal composition according to claim 1 which produces a synergistic effect when applied to insects and mites.

9. Use of a composition according to any of claims 1 to 8 for controlling pests and disease vectors.

10. Use of a composition according to any of claims 1 to 8 as an insecticide and/or acaricide to be applied in conventional and unconventional crops.
